(19) United States
(12) Patent Application Publication
(10) Pub. No.: US 2015/0269806 A1
(43) Pub. Date: Sep. 24, 2015

(54) SYSTEM AND METHOD FOR RECEIVING BONUS CREDITS THROUGH A JUKEBOX CONTROLLED BY A MOBILE DEVICE

(71) Applicant: AMI Entertainment Network, LLC, Trevose, PA (US)

(72) Inventors: Ronald RICHARDS, Elmhurst, IL (US); Charles JAROS, Chicago, IL (US); Anthony ALESIA, Harwood Heights, IL (US)

(21) Appl. No.: 14/662,924

(22) Filed: Mar. 19, 2015

Related U.S. Application Data
(60) Provisional application No. 61/968,644, filed on Mar. 21, 2014.

(51) Int. Cl. G07F 17/00; G06Q 20/32; G06Q 30/02

(52) U.S. Cl. CPC G07F 17/0035; G06Q 30/0222; G06Q 20/3224

(57) ABSTRACT

A system for awarding bonus credits to a user based upon payment of currency to play songs and/or videos includes a mobile device having a display and a mobile wireless communication implement, a jukebox having speakers and a central server in communication with the jukebox or the mobile device. The system configured to permit communication between the mobile wireless communication implement and the central server. The central server configured to track the payment of currency to play songs and/or videos by the mobile device and to award bonus credits to the mobile device based upon predetermined schedules.

### CROSS-REFERENCE TO RELATED APPLICATIONS

This application claims the benefit of U.S. Provisional Patent Application No. 61/968,644, filed on Mar. 21, 2014, entitled “System and Method for Receiving Bonus Credits Through a Jukebox Controlled by a Mobile Device,” the entire contents of which are incorporated herein by reference in their entirety.

### BACKGROUND OF THE INVENTION

Jukeboxes may have tiered pricing models where patrons convert dollars into credits to be used for song purchase at the jukebox. The pricing tiers are set up so that larger dollar purchases result in disproportionately larger numbers of credits. For example, one dollar ($1) may purchase two (2) credits while five dollars ($5) may purchase twelve (12) credits. In addition to purchasing credits with cash inserted at the jukebox, modern jukeboxes accept play requests from smart phone applications. It is desirable that funds used for smart phone purchases are held on the smart phone device or in accounts held on behalf of the smart phone user. Since purchases are made from the smart phone or other personal communication device one song at a time, the traditional tiered pricing model for cash purchases at a jukebox typically does not apply.

It would be desirable to design, construct and deploy a system and method for implementing a bonus credit scheme for a jukebox that is controlled through a patron's portable device, wherein the bonus credits are awarded to the patron during a “session” of the system at a particular venue having a single jukebox or at a plurality of related venues or venues with jukeboxes that are in communication with a central server and/or cloud server. The system may have numerous jukeboxes or a single jukebox and may be configured to operate with other gaming devices, in addition to jukeboxes or in combination with jukeboxes.

### BRIEF SUMMARY OF THE INVENTION

Briefly stated, the preferred embodiment of the device and method includes bonus credits based on credits consumed at a given jukebox venue within one “session.” The preferred embodiment offers a bonus for spending more than a base amount of wallet dollars at the jukebox (e.g. 12 credits for $5 instead of 10 credits for $5). Bonus credits at the Jukebox are offered based on cash placed in the Jukebox. Once the cash-in reaches a threshold, the bonus credits are awarded. On the user's smart phone or other portable device, bonus credits are based on credits used for song purchases. Accordingly, bonus credits are preferably triggered once a certain number of purchases are made on the same jukebox, within the same venue or on the same system during a “session.” Using a five dollar ($5) base amount or vend as an example, if a patron placed $5 into the preferred Jukebox, they would immediately receive twelve (12) credits to use. If instead, the user placed $5 in her wallet on their portable device and checked into the same venue, she would see only ten (10) credits. After spending those ten (10) credits at the same venue, she would be awarded two (2) additional bonus credits. Messages displayed on the smart phone or other portable device would teach the patron how bonus credits on the smart phone or other portable device are earned. Accordingly, the portable device would receive a signal to or would automatically display messages to the user to teach the patron how the bonus credits are awarded and/or earned on a display screen of the portable device.

The preferred method and system of the present device also includes a “session” or period of time related to a venue(s) that is used to capture the patron using the system. At the jukebox, a session is marked by boundaries where the credits go to zero. In between zero credits, all funds put into the jukebox count towards bonus credits. Using the preferred system and/or method, a session is preferably defined based on a period of time of use of the preferred system and method at a single venue.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown and described in the specification and drawings embodiments which are presently preferred. It should be understood, however, that the invention is not limited to the precise arrangements and instrumentalities shown. In the drawings:

FIG. 1 is a front perspective view of a portable or mobile device or smart phone in accordance with a preferred embodiment of the present invention, wherein a first graphical user interface (“GUI”) is depicted on a display of the portable or mobile device;

FIG. 1A is a front perspective view of a jukebox in accordance with the preferred embodiment of the present invention that may communicate with the portable or mobile device of FIG. 1;

FIG. 2 is a front perspective view of the portable or mobile device of FIG. 1, wherein a second GUI is depicted on the display;

FIG. 3 is a front perspective view of the portable or mobile device of FIG. 1, wherein a third GUI is depicted on the display;

FIG. 4 is a front perspective view of the portable or mobile device of FIG. 1, wherein a fourth GUI is depicted on the display;

FIG. 5 is a front perspective view of the portable or mobile device of FIG. 1, wherein a fifth GUI is depicted on the display;

FIG. 6 is a block diagram of communications between the portable or mobile device of FIG. 1, a server cloud or central server and the jukebox of FIG. 1A, in accordance with the preferred embodiment of the present invention;

FIG. 7 is a block diagram of exemplary pricing information communication between the jukebox of FIG. 1A and the mobile device of FIG. 1, in accordance with the preferred embodiment of the present invention; and

FIG. 8 is a block diagram of an exemplary purchase message flow between the mobile device of FIG. 1 and a mobile server, in accordance with the preferred embodiment of the present invention.

### DETAILED DESCRIPTION OF THE INVENTION

Certain terminology is used in the following description for convenience only and is not limiting. Unless specifically set forth herein, the terms “a”, “an” and “the” are not limited to one element but instead should be read as meaning “at least one.” The words “right,” “left,” “lower,” and “upper” designate directions in the drawings to which reference is made. The words “inwardly” or “distally” and “outwardly” or “proximally” refer to directions toward and away from, respectively, the geometric center or orientation of the portable or mobile device, the jukebox and related parts thereof. The terminology includes the above-listed words, derivatives thereof and words of similar import.

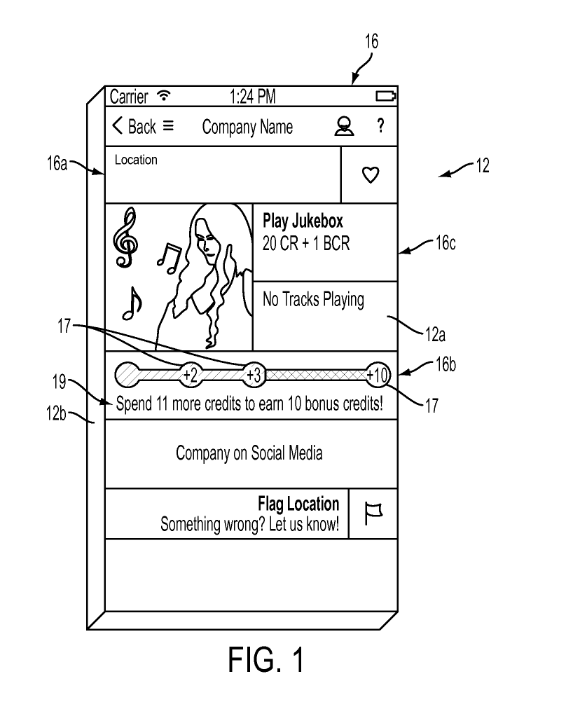

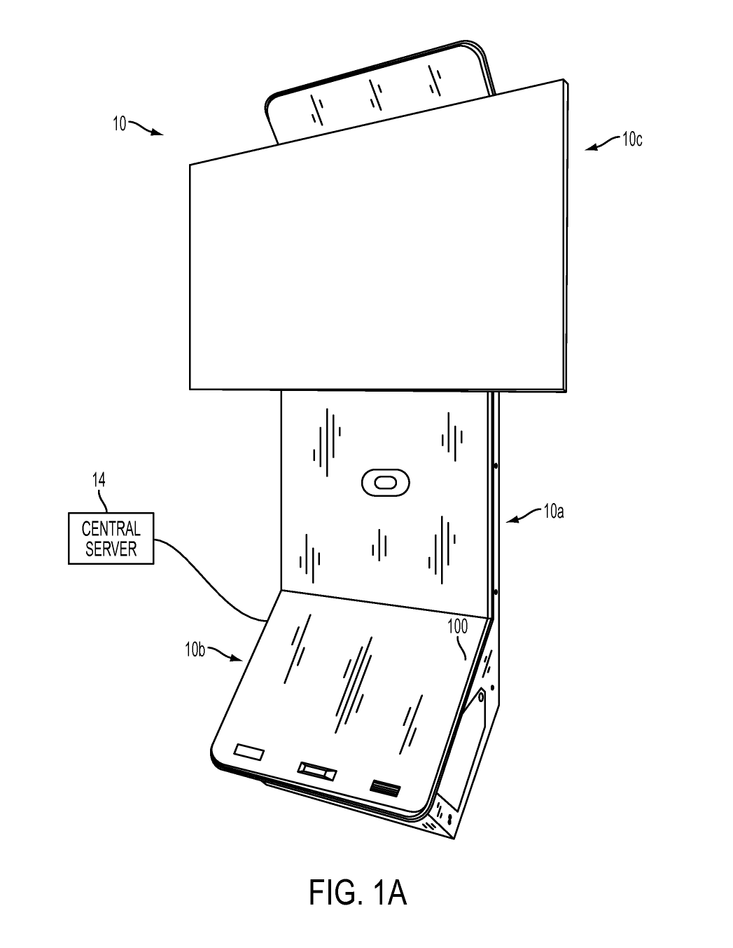

Referring to FIGS. 1-6, the preferred embodiment of the present invention relates to a system and method for receiving or awarding bonus credits through a jukebox 10 controlled by a portable or mobile device 12. The jukebox 10 preferably includes a frame 10a, a control panel 10b and a video board 10c, but is not so limited and may have nearly any components and/or features of a jukebox. The portable or mobile device 12 preferably includes a display 12a and a body 12b. The portable or mobile device 12 may be a portable phone, cell phone, tablet, smart phone or other related portable device that is able to wirelessly communicate with a central and/or cloud server 14. The portable or mobile device 12 may alternatively communicate wirelessly with the jukebox 10, but direct communication between the mobile device 12 and the central server 14 is preferred. The central server 14 may be located remotely from the jukebox 10 and may be configured as a cloud server 14, may be located remotely from a plurality of jukeboxes 10, may be located within a jukebox 10, may be located at a venue that includes a plurality of jukeboxes 10 or may be otherwise arranged or positioned for controlling and communicating with one or more jukeboxes 10 and/or mobile devices 12. The central server 14 may include multiple servers and/or devices, such as a mobile server 14a, and preferably includes several databases 15, such as a jukebox pricing database 15a, a player location session database 15b, a player location bonus database 15c and additional related databases 15. The patron or user is preferably able to control the jukebox 10 with their portable or mobile device 12 using the preferred system and method of the present invention.

Referring to FIGS. 1-2 and 6, the jukebox 10 and the mobile device 12 are both preferably in communication with the central or cloud server 14 to transmit and/or receive information to and/or from the central or cloud server 14. For example, the jukebox 10 is preferably in communication with the central server 14 to transmit jukebox pricing information, which may be customized and/or controlled by the jukebox operator, to the central server 14. The jukebox operator is preferably able to control the pricing of the jukeboxes 10 in their venue and is preferably able to quickly change the pricing of songs and videos on the jukebox 10 by communication with the central server 14. The operator is preferably able to modify pricing via a plurality of tiered pricing options that are provided by the central server 14 and/or by creation of custom pricing tiers by the operator. The central server 14 is also preferably in communication with the jukebox 10 to transmit queue songs to the jukebox 10 such that the queued songs may be played by the jukebox 10. The jukebox 10 is also preferably in communication with the central server 14 for several additional reasons, such as to manage available songs at the jukebox 10, to manage videos available at the jukebox 10 and for other reasons. The mobile device 12 is preferably in communication with the central server 14 through the mobile server 14a to send and receive location information, to send purchase information and to received purchase responses, to send and receive bonus information, to send and receive related messages and for other communications with the central server 14.

Referring to FIGS. 1-6, in the preferred embodiment, the patron or user requests to communicate with the jukebox 10 and/or the central server 14. Once communication is established, the jukebox 10 and/or the central server 14 preferably transmit a full pricing schedule to the central server 14. The full pricing schedule is preferably transmitted to the mobile server 14a where the pricing schedule is stored in a jukebox pricing database 15a. The portable or mobile device 12, the jukebox 10 and/or the central server 14 preferably keep track of a session of use between the mobile device 10 and a particular jukebox 10 or a particular venue, which may include several jukeboxes 10 or a network of jukeboxes 10 that are all in communication with the central server 14.

A session is preferably defined based on an interval of time between purchases and is preferably based on a predetermined timeframe. In the preferred embodiment, the session is tracked through a player location session database 15b and is preferably stored on the cloud server 14 to track and maintain the user's or player's session. The jukebox pricing database 15a, the player location session database 15b and other related databases are preferably maintained in databases 15 in the central server 14, but are not so limited and may be otherwise stored and/or arranged based on designer, owner and/or patron preferences. The interval of time, predetermined time or session may be configurable through the pricing schedule stored in the jukebox 10 and/or the central server 14 and the boundaries of a single session may be comprised of nearly any amount of time or determined based on interaction between the mobile device 12 and jukeboxes 10 in a particular venue or other factors.

As an example, the time interval or session may be comprised of a period of four (4) hours starting when the patron plays a first song on the jukebox 10 directed by the mobile device 12, but is not so limited. In this preferred embodiment, as long as a song purchase is made every four (4) hours during the session on the jukebox 12 or on any jukebox 12 that is in communication with the central server 14 in the jukebox network, the session will be kept “alive” or remain eligible for accrual of bonuses and the user associated with the mobile device 12 may accrue time and/or bonus opportunities related to the session that can be utilized to play additional songs and/or videos on the jukebox 10. In a preferred example, the session may be comprised of four (4) hours from the initial purchase of a song or video from the jukebox 10 in the jukebox network. The user is able to accrue bonus steps to obtain bonus credits during the session by purchasing additional credits during the session from the same jukebox 10 or from any jukebox 10 in the jukebox network that is in communication with the central server 14. For example, a user may make an initial purchase from a first jukebox 10 at a first venue that is in communication with the central server 14 at six (6) PM and subsequently make an additional purchase at the same venue from a second jukebox 10 in the venue before ten (10) PM to accrue bonus steps toward achieving bonus credit. Alternatively, the user may make a subsequent purchase at a different venue from a third jukebox 10 that is also in communication with the central server 14 and this purchase may also be used to accrue bonus steps toward the bonus credits. These subsequent purchases after the first six (6) PM purchase also preferably, but not necessarily, re-set the session such that the session continues for an additional four (4) hours or an alternative amount of time after each purchase from one of the plurality of jukeboxes 10 in the network. Once the session is completed or the user does not make a purchase during the predetermined timeframe in the preferred embodiment, the session is reset, the accrued bonus steps are set to zero and any additional purchases made by the user initiate a different session, wherein bonus steps must be accrued and the bonus goal must be attained before bonus credit is awarded. The system is not so limited and the bonus steps may be carried-over from one session to another, may be partially reduced between sessions or may be otherwise calculated, based on preferences.

The preferred central server 14 maintains multiple sessions with different jukeboxes 10 that are located at the same and/or different venues, but are each in communication with the central server 14. For example, if a patron switches between multiple jukeboxes 10 in the course of an evening, each one will have its own session and potential to earn bonus credits. A session and the cumulative purchase in that session preferably persist across starts and stops of the system and communication between the mobile device 12 and the jukebox 10 and/or central server 14 for purposes of achieving bonus credits such that the patron is able to play additional songs and/or play additional videos on the video board 10c of the jukebox 10. Once earned, a bonus credit is preferably maintained for the session or a predetermined length of time associated with the location record or venue for the jukebox 10. The bonus credits can preferably be consumed at any time prior to the expiration date. The initial time period for bonus credits may be comprised of nearly any amount of time, for example, in a preferred embodiment, the bonus credits may be utilized at any time over an initial time period of six (6) months.

Bonus credits that are earned by a patron or user during a session are preferably applicable to or may be used by any jukebox 10 associated with the venue wherein the jukebox 10 is positioned or with any jukebox 10 that is associated or in communication with the central server 14. In particular, the bonus credits preferably persist across a range of multiple jukeboxes 10 associated with the venue and may also persist across multiple jukeboxes 10 associated with or in communication with the central server 14. The bonus credits are preferably tracked and maintained in a player location bonus database 15c associated with the central server 14. When a preferred GUI is depicted on the display 12a of the mobile device 12 that includes available credits, the central server 14 and/or jukebox 10 preferably adds bonus credits to the available credits as the bonus credits are earned and the GUI preferably displays both available credits and bonus credits that are available to the patron, user or player. The GUI preferably displays the available credits and the bonus credits in such a way to be apparent that there is a distinction between the two, but is not so limited and may combine the available and bonus credits or may further break the credits into different categories. In the preferred embodiment, when bonus credits exist, they will preferably always be consumed prior to any wallet credits, but the system is not so limited and may be saved by the patron or user for later use. Bonus credits used on a song play preferably factor into the cost computation for a particular play at zero (0), such that the patron or user is not required to pay for the particular play. The bonus credits are preferably earned based on use of the preferred system by the patron or user and the bonus credits are not purchased directly with currency. A type code is preferably introduced to distinguish bonus credit plays from free credit plays in the central server 14 and/or the jukebox 10. Through messages depicted on the display 12a while purchasing songs, the jukebox 10 and/or the central server 14 preferably communicates with the mobile device 12, preferably through the central server 14, to inform the user how many credits must be used or other actions that are required to reach the next bonus session.

In the preferred embodiment, the central server 14 preferably maintains the databases 15 that keep track of the sessions and the accumulation of credits or bonus steps towards the next set of bonus credits. The bonus steps and bonus credits are preferably tracked on the central server 14 in the player location session database 15b. The central server 14 is not limited to tracking bonus steps and bonus credits via the player location session database 15b and may alternatively track and store bonus credits and the bonus credits or bonus steps may be tracked and stored in other manners, such as directly in the mobile device 12. A row is preferably created at the start of a new session in the player location session database 15b and the row preferably exists until the session expires. The central server 14 preferably records how many credits are used in the session, the number of bonus steps accrued, the expiration time of the session, the extension or reset of the session and the next bonus level. Progress towards a next goal for earning bonus credits or the amount of accrued bonus steps is preferably sent to the mobile device 12 from the central server 14 and/or the jukebox 10 when a user checks into a venue and after each song is played or at predetermined intervals. This data is preferably used by the mobile device 12 to present to the user via a progress indicator 19 on the display 12a, as the user progresses towards the next bonus award on the display 12a through the accumulation of bonus steps. Once a bonus is earned, the bonus is preferably tracked on the central server 14 in the player location bonus database 15c and preferably ties the bonus credit to a particular venue. This record preferably exists until the bonus is consumed or it expires after a predetermined amount of time.

The use of bonus credits is preferably non-compensated to the operator of the venue or location where the jukebox 10 is positioned or controlled, but is not so limiting and the operator may be compensated for such use. Use of the bonus credits preferably lowers the effective overall cost per play by injecting zero cost credits into the session. The jukebox 10, system and/or central server 14 is preferably not required to be configured in this manner and an operator may be compensated for song plays or displays of videos that result from bonus credits utilized by patrons and/or users. In addition, operators may be compensated at a different rate for song plays or video displays using bonus credits, which may be a percentage of typical plays or other varieties of protocols for compensating the operator.

In the preferred embodiment, bonus credits may be earned in various manners by a user or patron, preferably as a result of continued interaction with the system and/or through the purchase of multiple credits through the system. The following shows a preferred example of how the bonus credits are earned and illustrates the messaging to the user to communicate the bonus levels. The messaging to the user is preferably communicated at the display 12a.

Table 1, show below, provides a preferred illustration of the patron or user potentially earning bonus credits from the system as a result of spending five dollars ($5) at a new location or venue that has never been in communication with the patron's or user's specific mobile device 12. The below table indicates the action or state associated with the mobile device 12 or communicated from the mobile device 12 to the jukebox 10 or central server 14, the Wallet identifies the cash value associated with the user's account, the Credits identify the number of credits associated with the user's account and the Message indicates a message that is preferably generated by the central server 14 and transmitted to the mobile device 12 for depiction on the display 12a such that the preferred system is able to communicate with the patron or user to keep the user or patron up-to-date with changes and/or status of their account. The preferred system may also communicate with the user through the Message to encourage continued purchases of credits by the user, potentially based on the ability to earn bonus credits through the additional purchases. The Messages are preferably generated and tracked at the central server 14 and are transmitted from the central server 14 to the mobile device 12, but are not so limited and the messages may be tracked and generated at the mobile device 12, which may communicate with the central server 14.

TABLE 1

| Action/State | Wallet | Credits | Message |
|---|---|---|---|
| Enter System | $5 | 10 | |
| Enter Venue | $5 | 10 | Spend 10 more credits to earn 2 |
| | | | bonus credits |
| Play 2 Cr Song | $4 | 8 | Spend 8 more credits to earn 2 |
| | | | bonus credits |
| Play 2 Cr Song | $3 | 6 | Spend 6 more credits to earn 2 |
| | | | bonus credits |
| Play 2 Cr Song | $2 | 4 | Spend 4 more credits to earn 2 |
| | | | bonus credits |
| Play 2 Cr Song | $1 | 2 | Spend 2 more credits to earn 2 |
| | | | bonus credits |
| Play 2 Cr Song | $0 | 2 bonus | You just earned 2 bonus credits |
| Play 2 Cr Song | $0 | 0 | Spend 10 more credits to earn 3 |
| | | | bonus credits |

Table 2, shown below, illustrates the patron or user returning to a venue with accumulated bonus credits, mix of one credit & two (2) credit plays and the column identifiers are substantially equivalent to the column identifiers in Table 1. Specifically, in this preferred example of Table 2, the user returns to the venue with ten dollars ($10) of cash value in their Wallet, which corresponds to twenty (20) Credits. When the user initiates communication with the jukebox 10 in the venue, the mobile device 12 preferably communicates with the central server 14 to notify the central server 14 that the user is in the venue and the central server 14 determines that a bonus credit should be awarded to the user for communicating with the jukebox 10 at the venue. The central server 14 adds a bonus credit to the existing twenty (20) Credits, resulting in the user holding twenty-one (21) Credits. The central server 14 then sends a message to the mobile device 12 indicating to the user on the progress indicator 19 of the display 12a that additional bonus credits may be earned, preferably stating, “Spend 11 more credits to earn 2 bonus credits,” “Spend 10 more credits to earn 3 bonus credits” or another notification indicating to the user what actions may be taken to earn additional bonus credits and how many bonus credits are earned as a result of those actions. The user subsequently plays six (6) two (2) Credit songs, thereby using twelve (12) Credits and earning two (2) bonus Credits for spending eleven (11) or more credits at the venue. The central server 14 then communicates with the mobile device 12 by sending a message and showing a message on the progress indicator 19, such as “You just earned 2 bonus credits.” Following this message, the central server 14 then determines that additional bonus is preferably available for the user by spending nine (9) or more Credits, to accumulate ten (10) additional Credit plays following the initial bonus and communicates with the mobile device 12, sending a message stating, “Spend 9 more credits to earn 3 bonus credits” for display on the progress indicator 19. Between earning bonus Credits, the central server 14 also preferably communicates with and sends messages to the mobile device 12 updating the user through the display 12a with information about the number of additional Credit plays required to earn additional bonus Credits, which may be displayed on the progress indicator 19. The preferred bonus Credit strategy or structure shown in Table 2 also increases the bonus from two (2) Credits following the first play of ten (10) Credits to three (3) Credits following the second play of ten (10) Credits at the same venue. Such incremental increase in bonus Credits for Credit usage at the same venue is not limiting and may be alternatively employed by not incrementing bonus Credits or by more rapidly incrementing bonus Credits at the venue or during a specific user session at a single venue or across multiple venues.

TABLE 2

| Action/State | Wallet | Credits | Message |
|---|---|---|---|
| Enter System | $10 | 20 | |
| Enter Venue | $10 | 20 + 1 | Spend 11 more credits to earn 2 |
| which has one | | bonus | bonus credits |
| bonus credit | | | |
| Play 2 Cr Song | $9.50 | 19 | Spend 9 more credits to earn 2 |
| | | | bonus credits |
| Play 2 Cr Song | $8.50 | 17 | Spend 7 more credits to earn 2 |
| | | | bonus credits |
| Play 2 Cr Song | $7.50 | 15 | Spend 5 more credits to earn 2 |
| | | | bonus credits |
| Play 2 Cr Song | $6.50 | 13 | Spend 3 more credits to earn 2 |
| | | | bonus credits |
| Play 2 Cr Song | $5.50 | 11 | Spend 1 more credit to earn 2 |
| | | | bonus credits |
| Play 2 Cr Song | $4.50 | 9 + 2 | You just earned 2 bonus credits |
| | | bonus | |
| Play 2 Cr Song | $4.50 | 9 | Spend 9 more credits to earn 3 |
| | | | bonus credits |
| Play 2 Cr Song | $3.50 | 7 | Spend 7 more credits to earn 3 |
| | | | bonus credits |

Tables 1 and 2 provide examples of potential methods for awarding and/or using bonus credits of the preferred embodiment, but are not limiting, and the system may otherwise award and use bonus credits based on operator, owner, user, patron or other preferences.

Referring to FIGS. 1, 1A and 6-8, the central server 14 and/or jukebox 10 preferably communicates with the mobile device 12 to depict various GUI's on the display 12a to communicate with the patron or user with respect to the preferred system. A first GUI or location details GUI 16 preferably depicts a location 16a that is presently associated with the mobile device 12 and a jukebox 10 that the mobile device 12 is communicating with and/or controlling. The first GUI 16 also preferably includes a progress meter 16b that is preferably positioned directly under a jukebox cell 16c. Reward circles 17 on the progress meter 16b are preferably positioned to reflect the jukebox pricing structure that is stored in the jukebox pricing database 15a in the cloud or central server 14. The jukebox pricing structure is preferably communicated from the jukebox 10 through the mobile server 14a to the mobile device 12. The reward circles 17 of the progress meter 16b graphically represent to the patron or user when a bonus credit or bonus credits could be earned. The reward or bonus credit is preferably awarded after the reward circle 17 is filled, such that the patron or user is able to visually confirm that a bonus or reward was earned. The progress meter 16b preferably does not fill for spent or used bonus credits, but only fills as the user consumes cash from the Wallet or Credits that are directly associated with cash to play songs and/or videos on the jukebox 10. A message may also be shown on the first GUI 16, such as “Spend 11 more credits to earn 10 bonus credits!,” “Spend 1 more credit to earn 2 bonus credits,” “Spend 7 or credits to earn 3 bonus credits” or other similar notifications at the progress indicator 19 to communicate with the patron or user actions that earn additional bonus credits. The first GUI 16 is not limited specifically to the GUI shown in FIG. 1 and the first GUI 16 may be alternatively arranged for communication with the user.

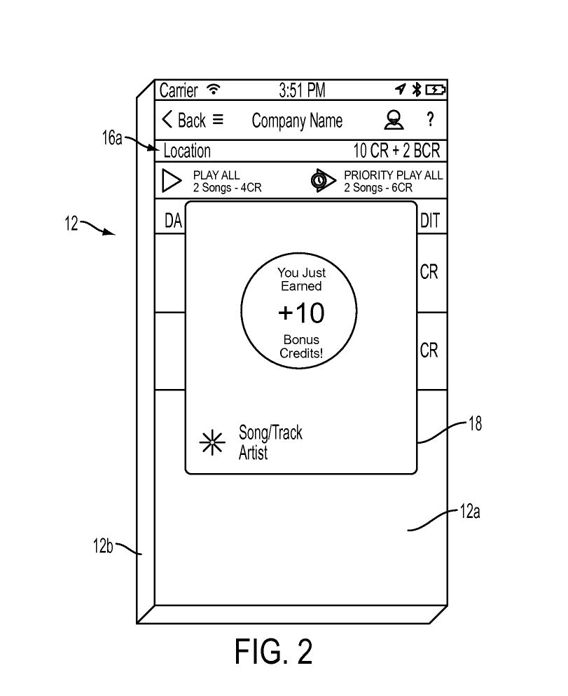

Referring to FIGS. 2 and 6-8, a second GUI or a bonus earned view GUI 18 is preferably dynamic in that the second GUI 18 animates or toggles in and out of view on the display 12 during a “Play All” mode of the system. The second GUI 18 preferably does not animate on this view if the mode has progressed to the last song on a list of songs and/or videos that are being played by the user and/or patron. The second GUI 18 preferably is depicted on the display 12a when a user has earned a bonus credit. Notifying the user that they have earned a bonus credit permits the user to potentially use the bonus credit during the current mode to play additional songs and/or videos using the bonus credit(s). The second GUI 18 is preferred to show the user mid “Play All” that they earned the bonus credit, because if the user is not notified of the bonus credit(s) and that they could spend the bonus credit(s), the user may not realize they have bonus credit(s) available and may feel they were unable to utilize the value that they earned. The “Play All” mode of the preferred system allows a user to select multiple audio and video tracks within a playlist or artist catalog. The second GUI 18 may present on the display 12a for a predetermined amount of time, may require the user to act, such as by touching the display 12a, before toggling off of the display 12a or may otherwise be configured to notify the user of the bonus. The bonus earned view GUI 18 may be prompted via a communication from the central server 14 following the determination of a bonus by the central server 14 or may be prompted by the mobile server 14a following a determination that a bonus is earned by the mobile server 14a.

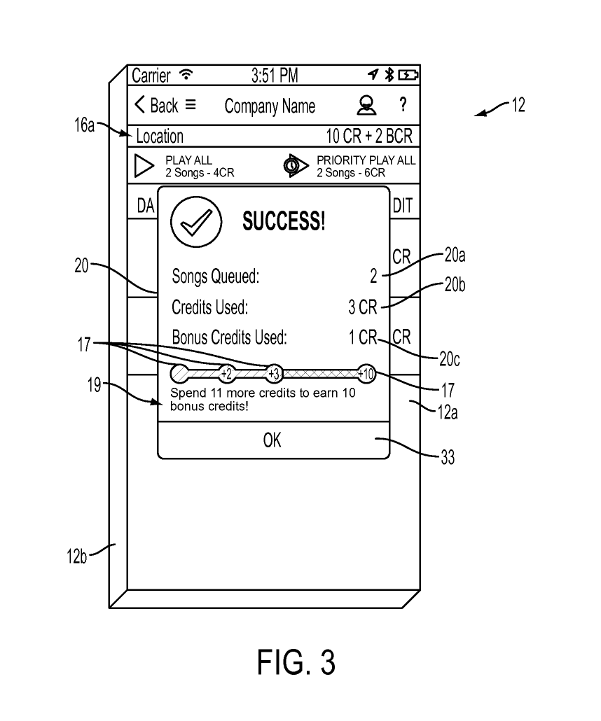

Referring to FIG. 3, a third or receipt view GUI 20 may also be utilized by the system to confirm that a song was played based on selection by the user. In the preferred embodiment, the second GUI 20 is depicted on the display 12a after any successful song play. A “Songs Queued” row 20a preferably shows the total of songs successfully queued by the user and may provide an indication of the name, artist or other identification of the next song or next several songs that are waiting to be played in the queue. A “Credits Used” row 20b preferably shows only the credits that came from a user's Wallet, as opposed to bonus credits that may be utilized to purchase and/or play the song and/or video. A “Bonus Credits Used” row 20c preferably shows any bonus credits used by a user in that venue or during a particular session. The second GUI 20 also preferably includes the progress meter 16b that starts from where the user was at the start of queuing or at the start of the session and animates to the end point (most recent information). The progress meter 16b may also provide an indication to the user of when the particular or existing session may end so that the user knows the completion of a session and opportunity or window for earning bonus credits is closing. The second GUI 20 also preferably includes the progress indicator 19 that provides a textual indication to the user of progress toward the bonus Credit and the additional bonus steps that are required to achieve the bonus Credit(s). The second GUI 20 further preferably includes a toggle button 33 that may be touched by the user at the touchscreen display 12a to toggle the second GUI 20 off of the display 12a.

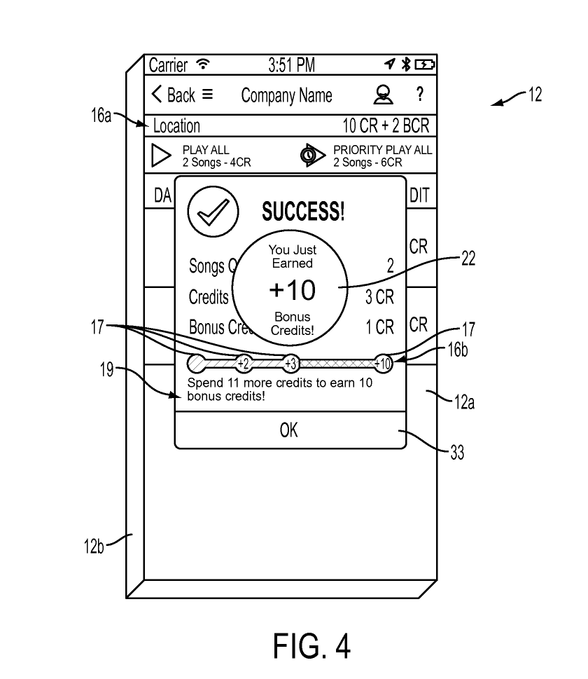

Referring to FIG. 4, a fourth or final bonus GUI 22 is preferably displayed if, on the last song played, the user gains bonus credit(s). Alternatively, the fourth GUI 22 may be depicted on the display 12a at an early time in the middle of a “Play All” period if the user earns bonus credit(s) during a series of song plays. The final bonus GUI 22 may also provide an indication of what a user can or may do to earn additional bonus credits on the progress meter 17 and/or the progress indicator 19. The final bonus GUI 22 also preferably includes the toggle button 33.

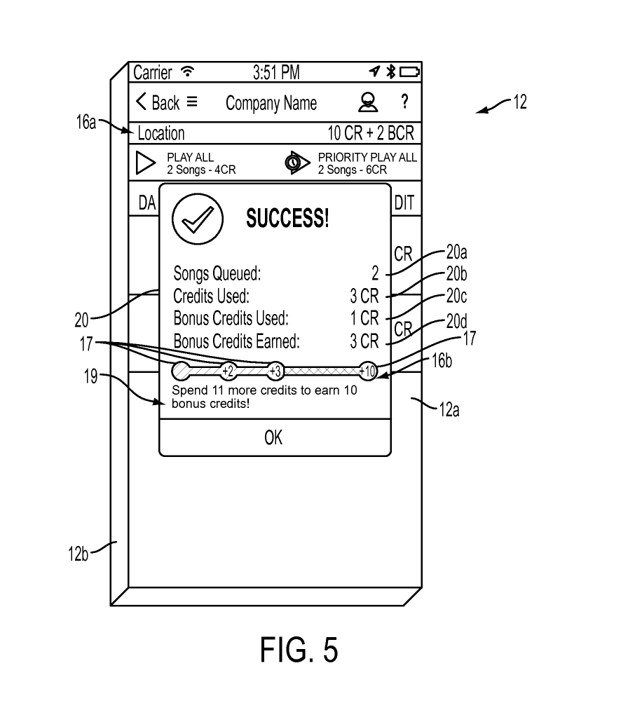

Referring to FIG. 5, the third or receipt view GUI 20 may be depicted on the display 12a to show a “Bonus Credits Earned” row 20d if any bonus credits were earned after play (any earned during play all).

Referring to FIGS. 1-8, the preferred system may be configured to send a message to queue a song on the jukebox 10 in response to a selection from the mobile device 12. The mobile device 12 preferably sends a message to the jukebox 10 and/or the central server 14 when a song or songs is selected for play by the user and the message is preferably used to queue a song on the connected jukebox 10. The “freePlay” field is preferably added for mobile plays. If the mobile free play is set to true, the jukebox 10 preferably sets the “playType” of that song to “mobileFreePlay” when logging the song play. This allows the proper cost of the play to be completed. The queued song request and queued song response messages may be represented, in the preferred embodiment, as follows:

Queue Song Request

```
{
  “message.type” : “jukebox.queuesong”,
  “message.id” : “<uuid>”,
  “songId” : <song id (num)>,
  “priority” : <play as priority (t/f)>,
  “purchasePrice” : <purchase price (num pennies)>,
  “sourceDeviceType” : <source device type (num)>,
  “sourceDeviceId” : <source device type (num)>,
  “transactionId” : <transaction id (num)>,
  “freePlay” : <free play (bool)>
}
```

Queue Song Response

```
{
  “message.type” : “jukebox.queuesong.re”,
  “message.id” : “<uuid>”,
  “jukeboxId” : <jukebox id (num)>,
  “transactionId” : <transaction id (num>,
  “message.result” : <result code (num)>
}
```

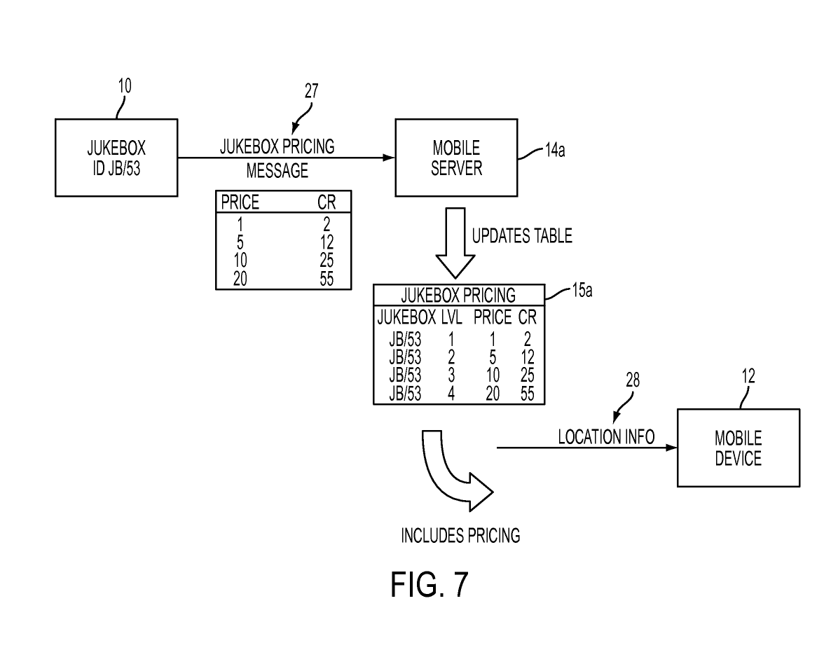

The jukebox 10 is also preferably in communication with the central server 14 for various reasons including to set-up, monitor and track pricing for the various jukeboxes 10 associated with the system. The flow of pricing information from the jukebox 10 to the central server 14 and then out to the mobile device 12 in the preferred embodiment is shown in FIG. 7. The pricing information or jukebox pricing is preferably communicated from the jukebox 10 to the central server 14 or mobile server 14a in a jukebox pricing message 27. Preferably the information from the jukebox pricing message 27 is stored in the database 15, preferably in the jukebox pricing database 15a, on the central server 14 so that it can be persisted and sent upon request at a later time to one or more mobile devices 12 when they “check in” to the venue where this jukebox 10 is located. For example, the jukebox 10 may send a message to the central server 14 related to pricing. This message may be sent to the central server 14 from the jukebox 10 on startup, when the pricing of songs changes in any way or at nearly any other time period. An example of sending the pricing structure and a response is, as follows:

Jukebox Pricing

```
{
  “message.type” : “realtime.jukebox.pricing”,
  “message.id” : “<uuid>”,
  “jukeboxId” : <jukebox id (num)>,
  “basePrice” : <base song price (num pennies)>,
  “priorityCharge” : <priority charge (num)>,
  “downloadCharge” : <download charge (num)>,
  “pricing” : [{“credits” : <credits (num)>,
        “price” : <price (num)>}, ...],
}
```

Jukebox Pricing, Response

```
{
  “message.type” : “realtime.jukebox.pricing.re”,
  “message.id” : “<uuid>”,
  “message.result” : <result code (num)>
}
```

The jukebox 10 may also communicate with the central server 14 and the mobile device 12 for various reasons, including to retrieve information for the above-described GUI's 16, 18, 20, 22. For example, if multiple jukeboxes 10 are in a venue, current jukebox status and now playing data is retrieved for each jukebox 10 and is transmitted to the central server 14 and/or the mobile device 12. In addition, tracking, award, display and storage of bonus credits may be calculated and maintained at the central server 14 and communicated to the mobile device 12 by various messages, but is not so limited and the jukebox 10 and/or mobile device 12 may conduct the same or similar functions without significantly impacting the operation of the preferred system.

Location Info

```
{
  “playerId” : <player id (num)>,
  “authentication” : “<authentication token>”,
}
```

Location Info Response

```
{
  =LOCATION=,
  “sessionProgess” : <session progress (num)>,
  “bonusBalance” : <bonus balance (num)>,
  “result” : <result code (num)>
}
```

Amount spent by a user at a location during a session is preferably calculated in pennies.
Bonus amount a user has at a location in pennies.

The mobile device 12 and/or jukebox 10 may further communicate with the central server 14 to update, manipulate and track the user's credits, payments, bonus and for other related reasons. For example, the mobile device 12 may communicate with the jukebox 10 and/or the central server 14 to consume money or credits from a user's account balance to purchase an item, such as playing a song or a video.

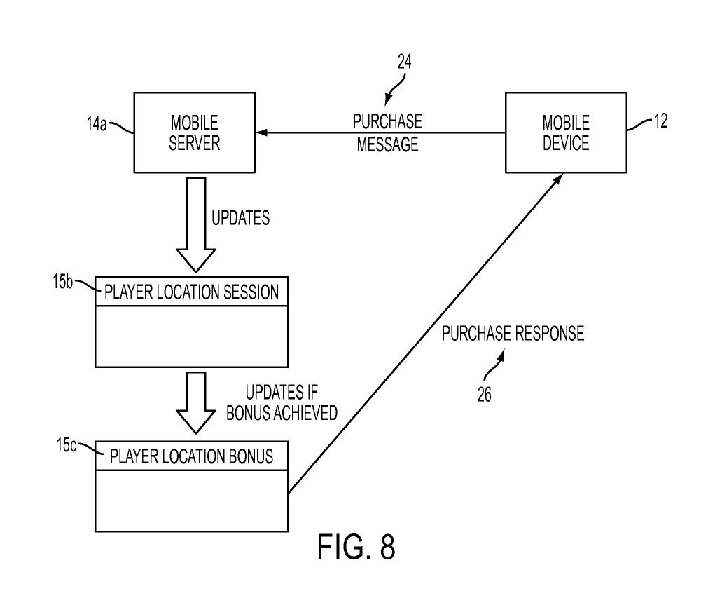

Message descriptions for a preferred message sequence for a purchase are depicted in FIG. 8 and shown below:

Purchase

```
{
  “playerId” : <player id (num)>,
  “authentication” : “<authentication token>”,
  “itemId” : <item id (num)>,
  “itemType” : <item type (num)>,
  “price” : <price of purchase(num pennies)>,
  “priorityPlay” : <priority play (bool)>,
  “sourceDeviceId” : <source device id (num)>,
  “sourceDeviceType” : <source device type (num)>,
  “destinationLocationId” : <location id (num)>,
  “destinationDeviceId” : <destination device id (num)>,
  “destinationDeviceType” : <destination device type (num)>,
  “promoCode” : “<promo code>”,
  “geocode” :
  {
    “lat” : <latitude (num)>,
    “lng” : <longitude (num)>
  }
}
```

Purchase Response

```
{
  “transactionId” : <transaction id (num)>,
  “sessionProgess” : <session progress (num)>,
  “bonusBalance” : <bonus balance (num)>,
  “result” : <result code (num)>
}
```

Amount spent by a user at a location during a session in pennies.
Bonus amount a user has at a location in pennies.

The process for purchasing a song may proceed with a purchase message 24 being sent from the mobile device 12 to the jukebox 10 or the central server 14 indicating that a song has been purchased. The central server 14 preferably completes the request by using bonus credits for the venue automatically, if available, the bonus credits used are subtracted from the amount and the remainder is preferably sent to the jukebox 10 when queueing the song.

A preferred purchase message workflow is shown in FIG. 8. In the preferred embodiment, the purchase message 24 is sent from the mobile device 12 to the mobile server 14a. The purchase message 24 preferably includes, among other items, the purchase price. The mobile server 14a communicates, via sending a message, with the central server 14 to update a row in the player location session database 15b to reflect the new spend amount in this session. If the spend amount is greater than the next spend threshold value, then one or more bonus credits is awarded based on the amount in the threshold bonus amount column, which may be calculated and stored by the central server 14. For example, if player pl#134 spends one hundred (100) cents on a song at a venue or location l#345 and the session record before the transaction is as follows:

| | | Last | session | | |
|---|---|---|---|---|---|
| | | selection | wallet | Next spend | Threshold |
| Player | Location | time | spend | threshold | bonus amount |
| pl#134 | L#345 | 9:35 | 300 | 500 | 2 |

Then as part of processing the transaction, the player location session database 15b of the central server 14 is updated, as follows:

| | | Last | session | | |
|---|---|---|---|---|---|
| | | selection | wallet | Next spend | Threshold |
| Player | Location | time | spend | threshold | bonus amount |
| pl#134 | L#345 | 10:15 | 400 | 500 | 2 |

In this preferred example, the player did not cross a bonus threshold and is not awarded bonus credit(s). However, if the player spends one hundred (100) more cents, his session_wallet_spend will reach five hundred (500) and the user will be awarded two (2) bonus credits in this preferred example, which is not limiting. The mobile server 14a preferably returns sessionProgress in a purchase response message based on the last value of the session_wallet_spend from the player location session database 15b. The updated bonus is also preferably returned in this purchase response message 26 and is preferably updated in the player location bonus database 15c.

A session preferably has a predetermined time period, for example, four (4) hours between purchases, i.e. if a song is purchased at eight (8) PM then the session will end after the predetermined time period or at eleven fifty-nine PM (11:59 PM). If during that window the user purchases a song at eleven PM (11 PM), then the session will be extended and end at two fifty-nine AM (2:59 AM). If the user crosses a pricing threshold, based on the pricing scheme from the jukebox 10, to earn bonus credits, then the “bonusBalance” is preferably updated to add the amount as such (basePrice×bonusCredits). A session preferably ends when the time limit expires or when the user reaches a last bonus level, if such a bonus threshold is desired by the operator and configured into the preferred system. The central server 14 preferably sends the updated “sessionProgress” and “bonusBalance” to the mobile device 12 in the purchase response message 26. The session timing may not be a constant amount of time and may be longer during traditional slow business times for a venue and comparatively shorter during traditional hectic business times for the venue.

The preferred databases 15 including the jukebox pricing database 15a, the player location session database 15b and the player location bonus database 15c, preferred examples of which are shown below:

Jukebox Pricing Database 15a

| | |
|---|---|
| device_status_id [int] | NOT NULL - PK |

| | | |
|---|---|---|
| pricing_level | [int] | NOT NULL - PK |
| price | [int] | NOT NULL |
| credits | [int] | NOT NULL |

The primary key is preferably device_status_id+pricing_level, the device_status_id is preferably foreign key of device status record, the pricing_level is preferably sort order index of pricing level, the price is preferably the number of pennies for that pricing level and the credits are preferably the number of credits for that pricing level, but these descriptions are not so limited and may be otherwise configured an arranged, based on user, operator and/or designer preferences.

Player Location Session 15b

| | | |
|---|---|---|
| player_id | [int] | NOT NULL - PK |

| | | |
|---|---|---|
| location_id | [int] | NOT NULL - PK |
| last_selection_time | [datetime] | NOT NULL |
| session_wallet_spend | [int] | NOT NULL |
| next_spend_threshold | [int] | NOT NULL |
| threshold_bonus_amount | [int] | NOT NULL |

The primary key is preferably player_id+location_id, the player_id is preferably foreign key of player record, the location_id is preferably foreign key of location record, the last_selection_time is preferably the time of last selection from the specific player for the specific location or venue, the session_wallet_spend is preferably the cumulative spend in cents for the specific location, the next_spend_threshold is preferably spend threshold in cents that earns the next bonus credits and the threshold bonus amount is preferably the number of bonus credits to be earned when spending threshold is met. The last_selection_time is preferably used to validate that the next spending event is within the same session. If the gap between the last selection and this section is greater than the configurable threshold, a new session is started for this specific player, location combination.

Player Location Bonus Database 15c

| | | |
|---|---|---|
| player_id | [int] | NOT NULL - PK |

| | | |
|---|---|---|
| location_id | [int] | NOT NULL - PK |
| bonus_credits | [int] | NOT NULL |
| expiration_date | [datetime] | NULL |

The primary key is preferably player_id+location_id, the player_id is preferably foreign key of player record, the location_id is preferably foreign key of location record, the bonus_credits is preferably the number of bonus credits left to be used for this player at this location or venue and the expiration_date is preferably the expiration date of the bonus credits. The number of bonus credits is preferably subtracted or decremented when consumed and the “NULL” associated with the expiration_date indicates that bonus credits do not expire.

In addition to granting bonus credits in response to purchases at the mobile device 12, a web based interface can be used to update the accounting of bonus credits for a given player at a given location. This preferably permits owners of the jukebox 10, owners of the venue or employees of the music network provider to grant bonus credits to users based on internal business policies. An increase in bonus credits for a given player gives them the ability to select plays without the use of cash held in the wallet of the mobile device 12. A preferred business rule could be employed or deployed to implement a reward program that computes purchases over a period of time and based on those purchases can compute an amount of bonus credits to grant to a particular user. The granted bonus credits allow that user to select a certain number of plays free of charge.

Location information messages 28 may be transmitted between the mobile device 12 and the central server 14 to verify and/or confirm the location of the mobile device 12 and jukeboxes 10 that are proximate the user's location. Message descriptions for a preferred message sequence for location services are shown below:

Location Message

```
“id” : <location id (num)>,
“name” : “<location name>”,
“type” : <location type (num)>,
“address1” : “<location address1>”,
“address2” : “<location address2>”,
“city” : “<location city>”,
“state” : “<location state>”,
“zipcode” : “<location zipcode>”,
“logo” : “<url of location logo>”.
“phone” : “<location phone number>”,
“mobileEnabled” : <mobile enabled (bool)>,
“geocode” :
{
  “lat” : <latitude (num)>,
  “lng” : <longitude (num)>
},
“devices” :
[
  { =DEVICE= },
  { =DEVICE= },
  ...,
]
```

Location and Pricing Response

```
“deviceId” : <device id (num)>,
“deviceType” : <device type (num)>,
“deviceName” : “<device name>”,
“mode” : <mode (num)>,
“canInteract” : <can interact (bool)>,
“canPlayVideo” : <can play video (bool)>,
“nowPlaying” : <song id or video id (num)>,
“nowPlayingType” : <the media type that is currently playing: 1 for song,
2 for video (num)
“priority” : <can play priority (bool)>,
“basePrice” : <base song price (num pennies)>,
“priorityPrice” : <priority play surcharge (num pennies)>,
“downloadPrice” : <download play surcharge (num pennies)>,
“videoPrice” : <video play surcharge (num pennies)>,
“isDemo”:<if current location is a Demo location or not, determined
based on the tv contract used (bool)>,
“channels” : [
{“channelIdentifier” : “<current channel identifier>”,
“channelVersion” : “<major version for channel currently used>”,
“gameChannel” : “true or false, 0/1”
},
  ...,
]
“pricing” : [{“credits” : <credits (num)>,
        “price” : <price (num)>}, ...],
```

The preferred system is configured to provide messages or prompts to users to notify the users that payment of additional funds to acquire credits will result in specific bonus grants or bonus credits. The messages are preferably sent from the central server 14 or the jukebox 10 to the mobile device 12 and depicted on the display 12a to notify the user that bonus credits or other bonuses are available and will notify the user what is required to earn the bonus.

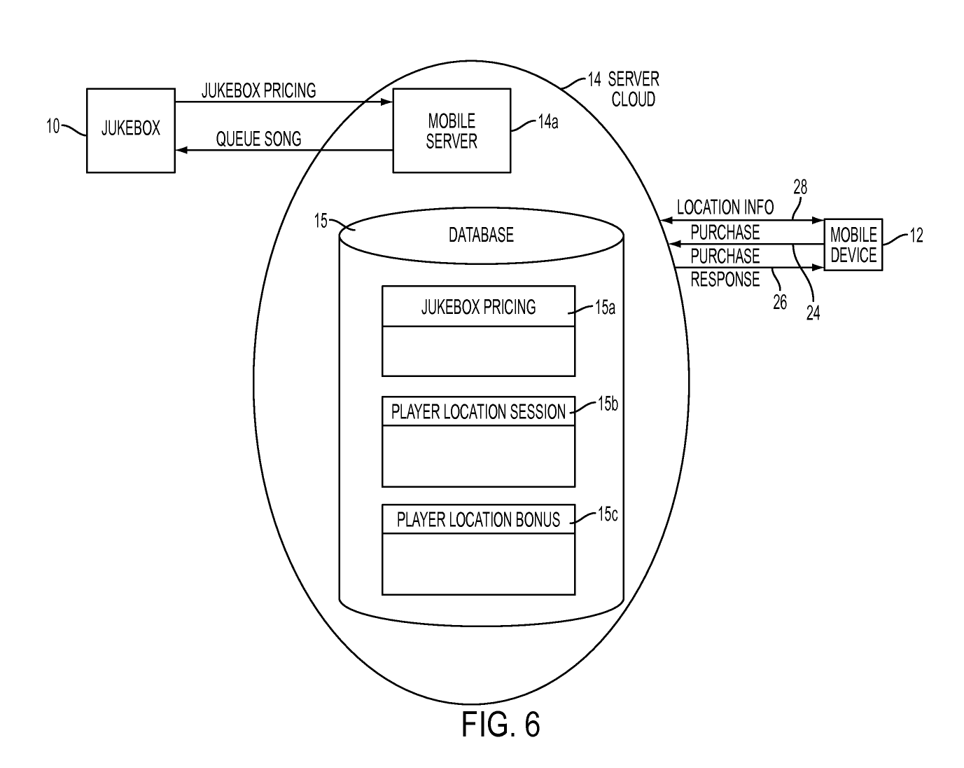

Referring to FIGS. 6-8, in operation, the preferred system awards bonus credits to the user of the mobile device 12 for purchasing songs for play on a first jukebox 10 in a jukebox network. The network may include several jukeboxes 10 at the same venue or numerous jukeboxes 10 at multiple venues. The plurality of jukeboxes 10 in the network are in communication with the central server 14 so that the central server 14 can track information related to the mobile device's 12 interaction with any of the jukeboxes 10 in the network, particularly during the session. In the preferred embodiment, the mobile device 12 communicates with or sends messages to the central server 14 to purchase songs and/or videos, notify the central server 14 of the jukebox 10 that should play the songs, submit payment information for the songs and/or videos and for other reasons related to the operation of the system. The mobile device 12 preferably communicates through a wireless network with the central server 14. The central server 14, in turn, preferably communicates in reply to messages and communication from the mobile device 12 with both the mobile device 12 and the jukebox 10 to have songs and/or videos played, update the user regarding bonus steps or credits, confirm payments, confirm the songs and videos were played, update the user regarding song and video queues and other related communications.

In the preferred embodiment, the central server 14 receives a first purchase message 24 from the mobile device 12 at the central server 14 when the user purchases songs and/or video from the mobile device 12. The first purchase message 24 includes first location information, first user information including identification of a first user, first payment information and first song identification information. The first location information includes information related to which of the plurality of jukeboxes 10 the mobile device 12 is in communication with and identification information related to the user and/or the mobile device 12 that is transmitting the message. The first location information is not limited to information related to the user, the mobile device 12 and the jukebox 10 and may include nearly any information that identifies the location of the mobile device 12, the user and/or the jukebox or jukeboxes 10 communicating with the mobile device 12. The first payment information preferably includes amount of payment, type of payment, type of currency and nearly any additional information related to payment, but is not so limited and may include more or less information related to payment for the songs.

The mobile server 14a and/or the cloud server 14 preferably determine, based on at least on the first location information, whether the mobile device 12 is in communication with one of the jukeboxes 10 in the network. When the mobile server 14a and/or the cloud server 14 determines that the mobile device 12 is in communication with the jukebox 10 in the network, the mobile server 14a and/or the cloud server 14 determines which one of the jukeboxes 10 is communicating with the mobile device 12. The mobile server 14a and/or the cloud server 14 then preferably update the appropriate databases 15.

The mobile server 14a and/or the cloud server 14 preferably initiate a first session upon receipt of the first payment information based on the information in the purchase message 24. The first session has a predetermined timeframe that is preferably calculated and tracked by the mobile server 14a and/or the cloud server 14.

The mobile server 14a and/or the cloud server 14 preferably transmit a first purchase message or purchase response 26 to the mobile device 12. The first purchase message or purchase response 26 includes a first confirmation of payment, first song play information and first bonus information. The first purchase message or purchase response 26 is not limited to including the specifically identified information and may include more or less information, based on user and/or designer preferences.

The mobile server 14a and/or the cloud server 14 then preferably receive a second purchase message 24 from the mobile device 12 during the predetermined timeframe or during the session. Accordingly, this second purchase message 24 indicates that the mobile device 12 is in communication with the same jukebox 10 or with a jukebox 10 in the same network during the session. The second purchase message 24 includes second location information, second user information including identification of the first user, second payment information and second song identification information. Based on the second purchase message 24 and the information therein, the mobile server 14a and/or cloud server 14 determines that the mobile device 12 is in communication with one of the plurality of jukeboxes 10 in the network or with the same jukebox 10 emanating from the first purchase message 24. The mobile server 14a and/or cloud server 14 then preferably resents the first session to restart the predetermined timeframe to extend the session based on this additional purchase of songs and/or videos from the network. The second purchase message 24 is not limited to including this specific information and may include more or less information related to the purchase of additional song and/or video plays during the session.

The mobile server 14a and/or the cloud server 14 subsequently transmits a second purchase message 26 to the mobile device 12, which includes a second confirmation of payment, second song play information and second bonus information. The first bonus information includes a first bonus step and the second bonus information including a second bonus step, wherein the first and second bonus steps are cummulative and related to the awarding of bonus credits during the session. Accumulation of bonus steps based on purchases from the network that are recognized by the mobile server 14a and/or central server 14 results in progress toward or awarding of bonus credits, preferably based on the number of purchases and the value of each of the purchases.

The system may also be configured such that the mobile server 14a and/or cloud server 14 receives a message from the mobile device 12 indicating the user is located at a first location or venue associated with a first jukebox 10. The message also preferably includes first purchase information, first payment information, first song identification and identification of a first user. The mobile server 14a and/or cloud server 14 may determine that the mobile device 12 is in communication with the first jukebox 10 based on the first location information. The cloud server 14 preferably initiates a first session upon receipt of the first payment information with a first predetermined timeframe. The first predetermined timeframe is preferably based on preferences of the operator of the venue where the first jukebox is located. The cloud server 14 then preferably transmits a first purchase message to the mobile device 12 including first confirmation of payment, first song play information and first bonus or first bonus step information. The cloud server 14 may then receive a second purchase message from the mobile device 12 including second location information, second user information including identification of the first user, second payment information and second song identification information. The cloud server 14 may receive this message when the user moves from the first venue to a second venue and wants to play a song and/or video on a second jukebox 10 in the second venue. The cloud server 14 preferably is able to determine that the first user is in the second venue and desires to play the song at the second venue based on the second location information. The cloud server 14 then preferably initiates a second session upon receipt of the second payment information having a second predetermined timeframe. The user may subsequently return to the first location or venue and send a third purchase message from the mobile device 12 to the cloud server 14. The third purchase message preferably includes third location information identifying the first jukebox, third payment information and third song information. If the third purchase information is received before the first session expires, the cloud server 14 preferably resets the first session to the first predetermined timeframe to extend the first session. Accordingly, the user may continue to add bonus steps for potential receipt of bonus credits based on song purchase at the first jukebox during the first session. Alternatively, each of the three described purchases could be utilized to accrue bonus steps for bonus credits. That is, each of the first, second and third purchases, even when the user is playing songs at different jukeboxes 10 in the network and visiting different venues, could qualify to accumulate bonus steps toward bonus credits in the first session and the first session may be reset upon receipt of the purchase message. In the preferred embodiment, however, when the user moves to a second location, which may be associated with a different bonus structure or tiered pricing schedule, the cloud server 14 tracks two sessions, one for each venue that have different bonus steps for accrual of different bonuses.

In an example transaction of the preferred embodiment, the first payment information of the first purchase message 24 includes a payment of ten dollars ($10) and the first song identification includes a first song and the first bonus information includes a message related to the amount of additional bonus steps required to earn an award of bonus credits. The bonus configuration of the preferred embodiment may be designed such that a total of ten (10) bonus steps is required to earn a bonus credit during a session. In another preferred example of the preferred embodiment, the first location information may include identification of the first jukebox 10 and the second location information may include identification of a second jukebox 10 of the plurality of jukeboxes 10.

During operation of the preferred system, the jukebox 10 may receive jukebox pricing information from the central server 14, wherein the jukebox pricing information includes a total number of bonus steps required to earn an award of bonus credits. The central server 14 may then send a bonus message to the mobile device 12 when the cumulative bonus steps reaches a predetermined bonus step threshold, indicating that the user is awarded at least one of the bonus credits.

It will be appreciated by those skilled in the art that changes could be made to the embodiment described above without departing from the broad inventive concept thereof. It is understood, therefore, that this invention is not limited to the particular embodiment disclosed, but it is intended to cover modifications within the spirit and scope of the present invention as defined by the present disclosure.

We claim:

1. A system for awarding bonus credits to a user based upon consumption of currency through the purchase of songs and/or videos with a mobile device having a display and a mobile wireless communication implement, the system comprising:
a jukebox including speakers; and
a central server in communication with the jukebox and the mobile device, the central server configured to track the payment of currency by the mobile device to play at least one of songs and videos on the jukebox and to award bonus credits to the mobile device based upon predetermined schedules, the predetermined schedules including a session comprised of a predetermined timeframe within which the user makes payments to accrue the bonus credits, the bonus credits being calculated during the session and bonus steps related to the bonus credits being reset at an end of the session, the central server configured to permit communication between the mobile wireless communication implement and the central server to track the payment of currency by the mobile device during the session.

2. The system of claim 1, wherein the jukebox includes a video board.

3. The system of claim 2, wherein the video board is comprised of a television.

4. The system of claim 1, wherein the jukebox includes a frame and a control panel.

5. The system of claim 1, wherein the display is configured to depict graphical user interfaces associated with the jukebox based upon messages received from one of the jukebox and the central server.

6. The system of claim 1, wherein the predetermined schedules include tiered pricing that offers the bonus credits for larger cash purchases at the jukebox based on incremental song purchases at the jukebox.

7. The system of claim 1, wherein the jukebox is comprised of a plurality of jukeboxes comprising a network of jukeboxes in communication with the central server, the central server tracking the payments in the network during the session.

8. The system of claim 1, wherein the central server is configured to offer bonus credit levels to the user based on a venue selected by the user of the mobile device, the central server tracking the venue selected based on location information messages transmitted between the mobile device and the central server.

9. The system of claim 1, wherein the mobile device is configured to depict progress toward a bonus credit grant of bonus credits on the display.

10. The system of claim 1, wherein the central server is configured to track and calculate the bonus credits of the user for at least one of a plurality of venues.

11. The system of claim 10, wherein each one of the plurality of venues has a different level of bonus credits earned.

12. The system of claim 1, wherein the session is extended when the user makes a payment to the central server to purchase at least one of the songs and videos.

13. The system of claim 1, wherein the central server includes a jukebox pricing database, a player location session database and a player location bonus database.

14. The system of claim 1, wherein the central server resets the bonus steps at the end of the session to zero.

15. A method for awarding bonus credits to a user of a mobile device for purchasing songs for play on a first jukebox in a jukebox network, the plurality of jukeboxes being in communication with a central server and being part of a jukebox network, the method comprising:
receiving a first purchase message from the mobile device at the central server, the first purchase message including first location information, first user information including identification of a first user, first payment information and first song identification information;
determining, based on at least the first location information that the mobile device is in communication with the first jukebox;
initiating a first session upon receipt of the first payment information, the first session having a predetermined timeframe;
transmitting a first purchase message to the mobile device from the central server including a first confirmation of payment, first song play information and first bonus information;
receiving a second purchase message from the mobile device at the central server, the second purchase message including second location information, second user information including identification of the first user, second payment information and second song identification information;
determining, based on at least the second location information that the mobile device is in communication with one of the plurality of jukeboxes;
initiating a second session upon receipt of the second payment information, the second session having a second predetermined timeframe;
receiving a third purchase message from the mobile device at the central server, the third purchase message including third location information identifying the first jukebox, third user information including identification of the first user, third payment information and third song identification information; and
resetting the first session to the predetermined timeframe.

16. The method for awarding bonus credits of claim 15, further comprising:
transmitting a second purchase message to the mobile device from the central server including a second confirmation of payment, second song play information and second bonus information, the first bonus information including a first bonus step and the second bonus information including a second bonus step, the first bonus step associated with the first session and the second bonus steps associated with the second session.

17. The method for awarding bonus credits of claim 15, wherein the first payment information includes a payment of ten dollars ($10) and the first song identification includes a first song, the first bonus information including a message related to the amount of additional bonus steps required to earn an award of bonus credits.

18. The method of awarding bonus credits of claim 15, wherein a total of ten (10) bonus steps is required to earn a bonus credit.

19. The method of awarding bonus credits of claim 15, wherein the first location information includes identification of the first jukebox and the second location information includes identification of a second jukebox of the plurality of jukeboxes.

20. The method of awarding bonus credits of claim 15, further comprises:
sending jukebox pricing information from the central server to the first jukebox, the jukebox pricing information including a total number of bonus steps required to earn an award of bonus credits.

21. The method for awarding bonus credits of claim 15, further comprising:
transmitting a third purchase message to the mobile device from the central server including a third confirmation of payment, third song play information and third bonus information, the first bonus information including a first bonus step and the third bonus information including a third bonus step, the first and third bonus steps associated with the first session and being cumulative.
